(19) United States
(12) Patent Application Publication
(10) Pub. No.: US 2004/0224740 A1
(43) Pub. Date: Nov. 11, 2004

(54) Simulation system

(76) Inventors: Timothy James Ball, Leigh (GB); Simon Christopher Ball, Leigh (GB)

Correspondence Address: Anthony R Barkume, 20 Gateway Lane, Manorville, NY, 11949, US

(21) Appl. No.: 10/343,755

(22) PCT Filed: Aug. 2, 2001
(86) PCT No.: PCT/GB01/03498

(30) Foreign Application Priority Data
Aug. 2, 2000 (GB) 0019299.
Mar. 16, 2001 (GB) 0106488.0
May 12, 2001 (GB) 0111673.0

(51) Int. Cl. G06F 17/00

(52) U.S. Cl. 463/6

(57) ABSTRACT

A competitive simulation game comprising a base program and at least one controllable object controllable by a player, characterised in that, in use, a real time input from a real life game controls a competitive object in the competitive simulation game as a competitor to the player.

This invention relates to a simulation system, and more particularly, but not exclusively, to a competitive simulation game. Examples of a competitive game are motor racing, bicycle racing and rowing.

Motor racing simulation games are well known, such as that sold by Electronic Arts Incorporated under the name F2000. This game runs on a personal computer and may be used with a steering wheel and pedals as a user interface. The steering wheel may provide the player with physical feedback to increase realism. Such a steering wheel is disclosed in U.S. Pat. No. 5,868,573, which is co-owned by the present applicant.

The F1 2000 game is partly loaded on to a hard drive, and is partly run from RAM in the personal computer and from a CD-ROM.

In operation, the simulation game combines a simulated track and a simulated car. The simulated track is mapped on to a computer in the form of a mesh made up of a series of spaced points, the position of which are approximated from physical estimations of a real track. The mesh is cloaked in various shades of gray to make the track appear similar to the real track. The simulated car is modelled on a real car's dynamic capabilities. The simulated car has many adjustable features, such that the car can be “set-up” to suit a particular track. The sort of features which can be changed affect the dynamics of the car, comprise: type of tyres, aerodynamic wing set-up, suspension set-up and gear ratios.

It is known to daisy chain several computers together and to set up each computer with the same track, each having a different simulated car. Each simulated car has a position along a track at any given point in time. The position of each car along the track is transmitted to each computer. The players can race against each other in their individual simulated cars so that a competitive simulation game can be played. This can be accomplished by linking computers together in a local area network or a wide area network.

Prior published PCT Publication No. WO 96/31831 discloses an electronic system for sporting contests or the like between professional competitors moving around, live, in a real environment and amateur competitors located elsewhere and not in the actual location of the contest moving around in the same environment in virtual reality, the real environment having means to determine the position and the movement of the professional competitors in the real environment, characterised in that it has:

a server device having means in which all the information about the real competition is stored and, in particular, the identity of the real environment, the professional competitors taking part in the competition, the outside environment such as the weather conditions, the state of the real environment, the starting and finishing times of the competition and the positions of the professional competitors during the competition,

at least one local server device, which is connected on the one band to said server device by first two-way communication channels and, on the other, to at least one terminal device associated with an amateur competitor by second two way communication channels, said local server device having means, on the one hand, for receiving information from said server device and transmitting it, after processing or not, to said terminal devices connected thereto and, on the other, for receiving information from the terminal devices and transmitting it, after processing or not, to said server device, and further characterised in that:

each terminal device has means, on the one hand, for receiving and processing the information received from the local server device to which it is connected, and, on the other, for processing the performance levels of the amateur competitor associated with the terminal device during the competition and transmitting the corresponding information to said local server device.

The method for locating a position of a racing car on a racetrack disclosed in PCT Publication No. WO 96/31931 is by a combination of taking an average speed of the racing car over a previous sector of a lap and a time at which the car passes one of three sensors spaced around the race track. Accordingly, only an approximate position along the length of the track can be deduced.

Simulation games are becoming more realistic. Playability is improving.

According to the present invention, there is provided a competitive simulation game comprising a base program and at least one controllable object controllable in use, by a player, characterised in that, in use, a real time input from a real life event controls the position of a competitive object in the competitive simulation game as a competitor to the player, the position defined by coordinates in at least one plane.

Such events include, for example motor car racing, motor bike racing, truck racing, rallying, motocross, horse riding, swimming, fishing, cycling, jet skiing, snow skiing, sailing, rowing and motor boat racing.

In the case of for example, motor racing, bicycle racing or rowing, an exact position of the competitive object will improve the realism in the simulation game. For instance, if a driver of a real life race car swerves suddenly, a player of the simulation game may be able to take advantage and overtake in the virtual environment of the simulation game, without having to change his driving line. Preferably, the at least one plane should be a substantially horizontal plane.

Advantageously, the real time input comprises at least one other descriptive element of the object. For example, details of damage the object may have suffered and changes in character.

Preferably, the real time input from a real life event controls the position of a competitive object in the competitive simulation game as a competitor to the player, the position defined by coordinates in at least two planes. A three-dimensional coordinates may be obtained by a combination of a two dimensional coordinates and a three dimensional mesh of a place at which the event is taking place. The two-dimensional coordinates may be mapped on to the mesh to obtain a three dimensional location of the competitive object. Or a three dimensional coordinates could be mapped directly on to the mesh.

Advantageously, the real time input comprises orientation of the object. The orientation of the object may be described in a flat plane, substantially flat plane or in a three dimensional orientation.

The object may be a vehicle, such as a motor car, bicycle, boat, motorcycle, truck or snow mobile.

Preferably, the descriptive element of the vehicle further comprises at least one of the following: road wheel orientation; steering wheel orientation; weight; and fuel load.

Advantageously, the real time input is uploaded into the base program via a satellite link or broad bandwidth line. Preferably, the real time data is sent in a bit stream. The broad bandwidth line may be an optical fibre or an ADSL line or DDSL line or be transmitted by satellite. The broad bandwidth may be as small as 56 kb/s through an analogue line modem, although larger bandwidths are preferred.

Preferably or alternatively, the real time input is uploaded from the data obtained from the real life game to the internet, and downloaded into the base program from which the competitive simulation game is played. The data transmitted over the internet is generally sent in packets of compressed data. The compressing and decompressing of the packets coupled with delays in sending over the internet reduces the probability of the data reaching the games console or base program in a manner which will allow a player to feel a smooth operation of the simulation. Accordingly, buffers may be used to store the relevant information such that a player uses the simulation a few seconds after the real event. Thus by using buffers, the simulation is effectively time shifted by a few seconds or perhaps up to a few minutes.

Advantageously, the base program is stored on a personal computer or games console.

Alternatively or additionally, the base program is stored on a computer forming part of the internet (such as an Application Service Provider), which may be accessed through a dumb terminal or a personal computer.

The invention also provides a games console, a simulator and a training simulator comprising the competitive simulation game.

According to a second aspect of the invention, there is provided a method of obtaining track data, comprising the step of scanning a track from at least one reference point, and inserting an electronic image of the track into a base program.

The track data may comprise three-dimensional co-ordinates of the surface of the track.

If desired, the scanning may be conducted from a series of defined points located around the track. Or from several undefined points, the sections of track subsequently joined together, such that only relative positions are required.

Alternatively or additionally, the scanning may be conducted from the back of a flatbed truck or from an aeroplane preferably, in a single sweep.

Preferably, the track may comprise one of the following: a tarmac looped track, such as that used in Formula 1, Indy car or Nascar; a road track, such as that used in bicycle road races, such as the Tour de France; a substantially mud track, such as used in car rallying, moto cross or mountain bike races; and a river and river banks, such as that used in boat races, such as the stretch of the Thames used in the Oxford and Cambridge boat race.

Advantageously, the scanning is conducted immediately prior to an event occurring on the track. Immediately may be considered to be one day or one week in advance of a motor racing or road bike event on a tarmac track or may be five minutes to one hour in advance of a rallying event, in which the track and track conditions and properties can change relatively quickly with varying weather conditions and previous cars damaging or altering the track.

Preferably, the computer program is a base program of a racing simulation game. Alternatively or additionally, the computer program is used to assess the quality of the track for test purposes and as an aid for designing tracks. Alternatively or additionally, the computer program is used in television program production to simulate incidents of interest which have been missed by cameras. Advantageously, the method comprises the step of combining the scanned image of the track with track conditions and track properties obtained from other means. The other means may include analysis of the scanned image to deduce the condition or properties of the track. For example, the scanned image may be used to judge the adhesive qualities of the track, or how slippery a surface will be, particularly, but not exclusively, for a muddy rallying track. The accuracy of this can be improved with additional sensors and other indicators such as temperature and barometric measurements.

Preferably, the track conditions and properties include adhesive qualities, temperature, humidity, dampness, wetness and visibility.

If desired, the condition of the track may be continually monitored and data transmitted to update the base program as and when a significant change occurs, for example oil spill or shower of rain.

The second aspect of the invention also provides a computer simulated track modelled using the method set out in the above statements.

According to a third aspect of the invention, there is provided an apparatus for inserting pre-race data into a base program, the apparatus comprising means for obtaining the pre-race data, means for uploading the pre-race data on to the internet and means for downloading the pre-race data into the base program. Preferably, the pro-race data includes at least one of the following: track information and car set up. The pre-race data such as track information may be obtained from scanning, as set out above. Other pre-race data such as car set-up may be manually keyed in, or imported from a specific program which calculates car set-up parameters, as set out herein.

The means for uploading the pre-race data may comprise a modem or a fixed communication channel for uploading the pre-race data on to a computer on the internet.

The means for downloading pre-race data may comprise a home computer or an application service provider or games console provided with a device, such as a modem, satellite set top box, cable set top box or other data communication device. The third aspect of the invention also provides a method for inserting pre-race data into a base program, the method comprising the steps of obtaining the pre-race data, uploading the data on to the internet and downloading the pre-race data into the base program.

According to a fourth aspect of the invention, there is provided a method of obtaining data for a simulated car competing against representations of real cars on a track, the method comprising the steps of obtaining data from a real car driving on a track and using the obtained data for obtaining an approximation of the simulated car's ‘optimum’ capabilities.

Preferably, the obtained data comprises the speed at at least one point on the track.

Advantageously, the obtained data is obtained from a near perfect performance from the car on the track.

Preferably, the obtained data is obtained before the competition.

Advantageously, the obtained data is obtained from the real car during the competition. Preferably, the obtained data is obtain from an average or otherwise statistically derived method of at least two real cars during the competition.

Preferably, the obtained data is processed using a prediction program, such that the simulated car's parameters are also submitted to the prediction program to obtain an approximation of the simulated car's ‘optimum’ capabilities.

There is also provided a competitive simulation game comprising an algorithm to carry out the method as set out above.

The real time data needed to send information about the competitive object and/or event, needs to be sent to the computer holding the base program reliably, quickly and preferably, in time with the televisual image of the event.

According to a fifth aspect of the invention, there is provided a method of transferring real time data relating to an event for use in a competitive simulation characterised in that the real time data is transmitted via a satellite link.

Preferably, the real time data may be received is directly from the satellite link at the location of the player. Using for example, a home satellite dish, the player may receive the real time data directly from a satellite.

Advantageously or alternatively, the real time data is received directly from the satellite link at a station and into a cable network for onward transmission to the location of the player. The cable network may be of that also used to transmit television programs, as is commonly available. This is advantageous for those players not able to receive directly from satellite, or those preferring cable.

It may be preferable to simultaneously transmit the real time data of an event with a televisual signal of the event. In such a case, the player may receive the real time data and televisual signal simultaneously, so that the player may watch the race in a window on his screen, or on a separate screen.

Preferably, the method further comprises the step of transmitting the real time data to a website on the internet, to which player's have access. Advantageously, the method further comprises the step of making available pre-race data on the website on the internet, to which player's have access. These steps could be useful for players wishing to access the real time data at a later time, or if the player has missed part of the event, but still wishes to start the event from the beginning. The information on the website will also be used as a back-up storage for all of the data obtained from the event. Advantageously, the pre-race data is also transmitted via a satellite link. This keeps all the incoming data on one link, which may improve ease of use.

Preferably, the event comprises an object and the real time data comprises a position coordinates of the object.

Exercising and fitness studios have changed dramatically over the past few years. Such studios now comprise a plethora of machines which emulate various sports, such as bicycles, tread mills and rowing machines. These machines are now found in homes as well as studios.

It has been noted that exercising on machines can be dull for the user and do not emulate their real life counterparts well enough. Machine manufacturers have placed visual displays on their machines. One such machine is a rowing machine, the visual display thereof displays a graphic image of two rowing boats: one indicating the position of the tower using the machine; and one indicating the position of a target rower. The rower can then judge how well he is doing by his position on the visual display, relative to his target. Although this creates a little interest and more realism, other ways are still needed to increase the enthusiasm of a person exercising on the machines. It is also advantageous for athletes to compete with other athletes frequently.

Sporting bodies and event organisers are also very keen to boost the popularity of their sport and events.

According to a sixth aspect of the invention, there is provided a simulation system comprising a position co-ordinates for at least one competitor in a real life event on a track, a computer for processing an image and position of said competitor on a representation of the track on a visual display and a user input device emulating the competitors, characterised in that said user input device is an exercise or training machine.

Advantageously, the position co-ordinates for the at least one competitor are transmitted to the computer in real time, so that the user of exercise machine can race with the actual competitor. Alternatively, the position co-ordinates for the at least one competitor are stored on a medium and transferred to a computer at a later time, such that a user of the exercise or training machine can exercise or train with the competitor in the event at a later time. The form of storage may be a hard drive, on a website or a CD ROM. The method of transfer may be by sale of a CD ROM or by transfer over the internet.

Preferably, the position co-ordinates are obtained using a Global Positioning Satellite, and may further be obtained using a beacon.

The event may take place at a location remote from the simulation system. For instance, the simulation system may be located in a gym, studio or in a home.

The track may comprise one of the following: a tarmac track, a looped track, a road track, a muddy road and a river.

The event may comprise one of the following: a velodrome cycling event, a road bicycle event, a mountain biking event, a walking event, a running event and a rowing event.

Preferably, a scanned image of the track is obtained, the scanned image loaded on to said computer and displayed on said visual display.

Advantageously, the position co-ordinates of the at least one competitor are transmitted from said event via satellite link. The position co-ordinates may be transmitted over the internet, although this might not provide a stable data transfer medium. Although this may be negated with the use of buffers.

Preferably, advertising banners appear on the visual display, which are associated with the event, or are linked with a user or user profile of the simulation system.

The sixth aspect of the invention also provides a method of training or exercising using the simulation system as set out above, comprising the steps of competing in virtual reality with at least one competitor in real time.

The sixth aspect of the invention also provides a competitor provided with a device for assessing the competitor's position co-ordinates, which device transmits said position co-ordinates to a main computer for onward transmission to a simulation system of the invention.

If the competitor competes on a bicycle or a rowing boat, the device may be located thereon.

Advantageously, the device reassesses said position co-ordinates and transmits said position co-ordinates to said main computer between every hundredth of a second and every five seconds.

The sixth aspect of the invention also provides a computer program for use in the simulation system of the invention, wherein said program includes an algorithm to accept positional co-ordinates and use them to display an image of the competitors cars on a visual display.

Television coverage of a race is not always complete. Camera placement about a track or course is expensive. Only a limited part of the track or course is covered at any one time. There are often ‘black spots’ which are areas of the track or course not covered by the cameras. If an incident occurs in a ‘black spot’, such as an overtaking manoeuvre, a retirement or a crash, the incident cannot be shown to a viewer. Another feature of the simulation system of the present invention, is that a simulation of the incident may be rendered from the position and orientation data of the race car. This can be shown in real time or shortly after the incident has occurred or been noticed.

According to a seventh aspect of the invention, there is provided a simulation comprising the steps of obtaining positional data from a competitor in an event, obtaining background information, rendering a representation of said competitor, rendering said background information and placing said representation of said competitor on to the rendered background information to form a picture and broadcasting or sending said picture to at least one viewer.

Preferably, the simulation further comprises the step of obtaining data regarding the orientation of competitor and orientation of the background, rendering a representation of said competitor therewith for placement on to said rendered background, such that the viewer will have an accurate representation of the orientation of the competitor in relation to the background.

Advantageously, the positional data is obtained using a GPS device arranged on said competitor.

Preferably, the data regarding the orientation of the competitor is obtained using a second GPS device arranged on said competitor and spaced in a first direction from said first GPS device. Advantageously, the data regarding the orientation of the competitor is obtained using a third GPS device and spaced in a second direction from said first GPS device, preferably orthogonal to said first direction.

Alternatively or additionally, the data regarding the orientation of the competitor is obtained using a gyroscopic device.

Advantageously, the steps of the simulation are carried out once every 25^{th} of a second to obtain a moving video simulation and more advantageously, every 50^{th} of a second.

Preferably, the simulation is carried out on the instruction of the viewer. Alternatively, the simulation is carried out by a commentator, editor or director of a broadcaster.

The seventh aspect of the present invention also provides an apparatus including a computer for carrying out the simulation of the invention.

Race car engineers need to talk to the drivers of the cars about the race car performance during testing, during the race and during debriefing. It is often difficult for an engineer to communicate the problems with the car and also for the driver to explain how the race car is performing in certain sectors of the race.

According to an eighth aspect of the invention, there is provided a simulation comprising the steps of obtaining positional data from a competitor in an event, obtaining background information, rendering a representation of said competitor, rendering said background information and placing said representation of said competitor on to the rendered background information to form a picture and sending said picture to at least one viewer and obtaining and displaying logged data next to said picture. An event may be a Grand Prix and includes the race, qualifying and testing.

Preferably, the simulation further comprises the step of obtaining data regarding the orientation of the competitor and orientation of the background, rendering a representation of said competitor therewith for placement on to said rendered background, such that the viewer will have an accurate representation of the orientation of the competitor in relation to the background.

Advantageously, the positional data is obtained using a GPS device arranged on said competitor.

Preferably, the data regarding the orientation of the competitor is obtained using a second GPS device arranged on said competitor and spaced in a first direction from said first GPS device. Advantageously, the data regarding the orientation of the competitor is obtained using a third GPS device and spaced in a second direction from said first GPS device, preferably orthogonal to said first direction.

Alternatively, the data regarding the orientation of the competitor is obtained using a gyroscopic device.

Advantageously, the steps of the simulation are carried out once every 25^{th} of a second to obtain a moving video simulation, such that 25^{th} pictures are formed every second, and more advantageously, every 50^{th} of a second, and most preferably every 100^{th} of a second or more frequently. Preferably, the logged data is displayed at the same intervals as the pictures.

Preferably, the logged data comprises at least one of the following: the speed, acceleration, deceleration, centripetal forces and weight of the race car. Advantageously, the logged data is displayed on a graph.

For a better understanding of the present invention, reference will now be made, by way of example, to the accompanying drawing, in which:

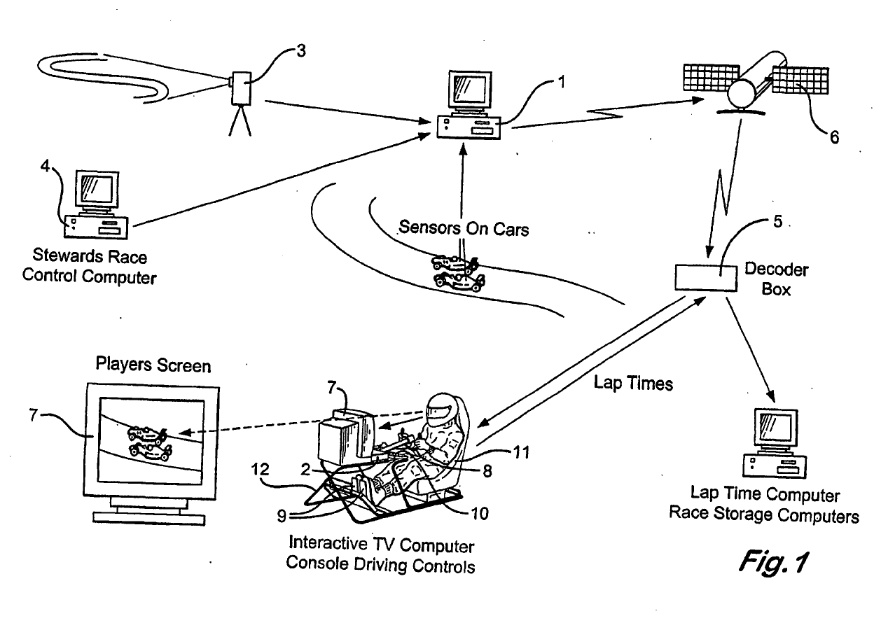

FIG. 1 is a schematic diagram of a simulation system in accordance with the present invention;

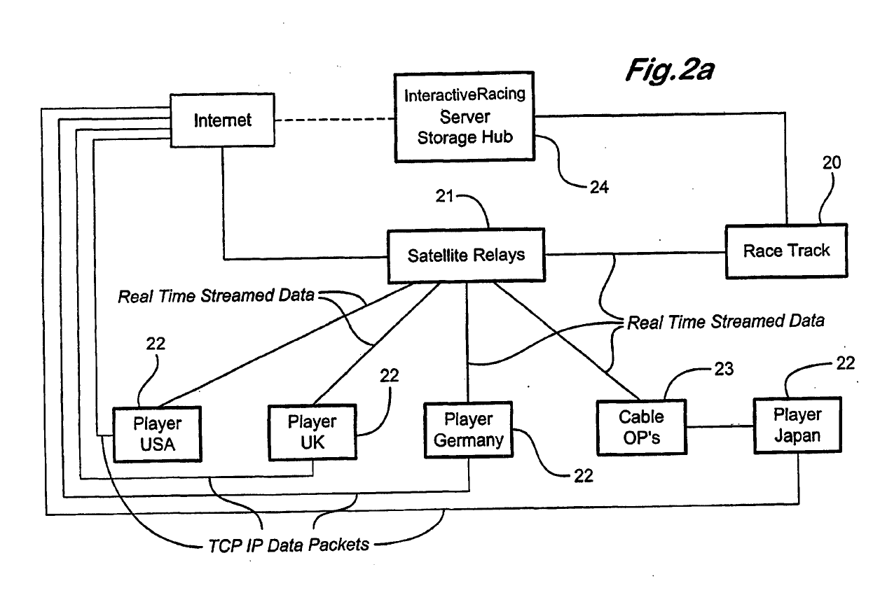

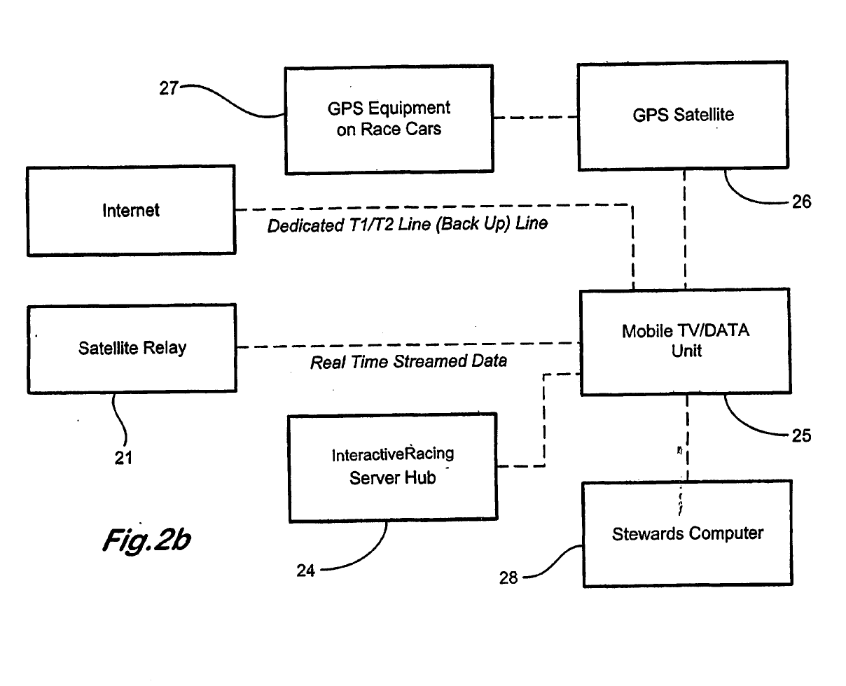

FIG. 2a is a schematic diagram of an arrangement for communication links in a second simulation system in accordance with the present invention;

FIG. 2b is a schematic diagram of part of the arrangement of FIG. 2a, which part is located at a racetrack;

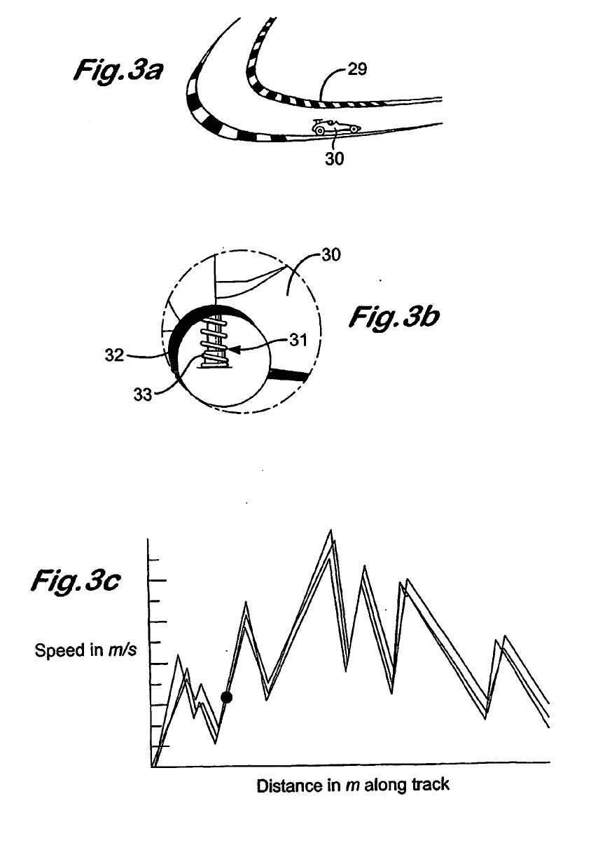

FIG. 3a is a schematic representation of a race car on a race track;

FIG. 3b is an enlarged view, with parts cut away, of part of the race car of FIG. 3a;

FIG. 3c is a graph showing how telemetric data from a race car is currently displayed;

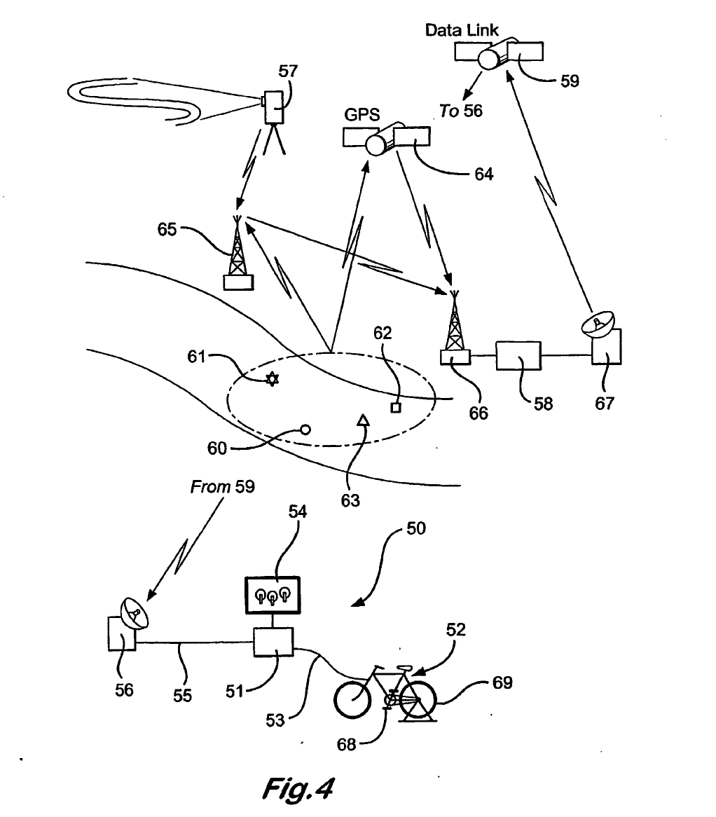

FIG. 4 is a schematic diagram of a second simulation system in accordance with the present invention; and

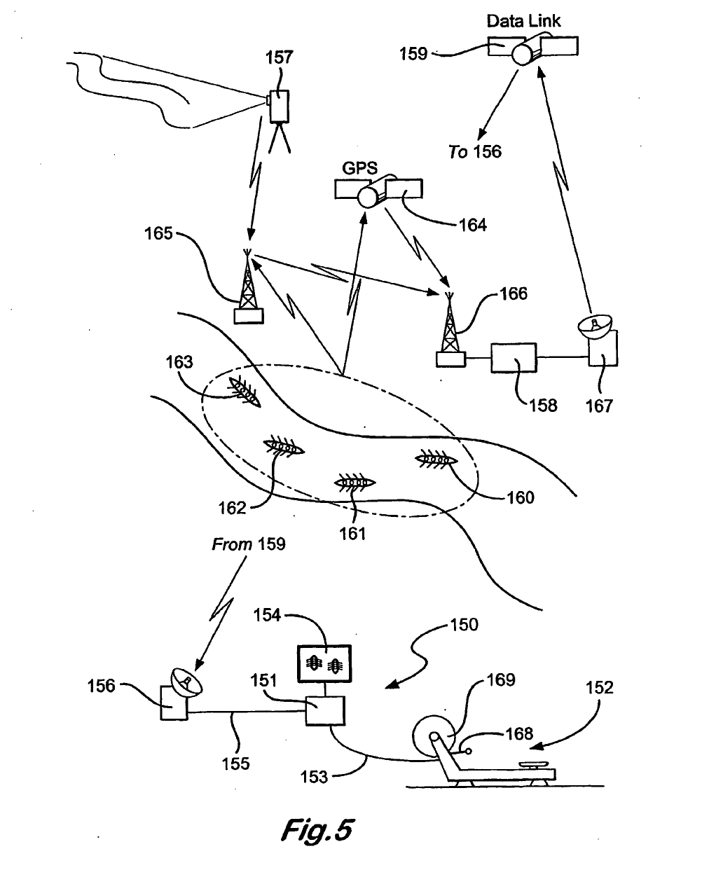

FIG. 5 is a schematic diagram of a third simulation system in accordance with the present invention.

Referring to FIG. 1, there is shown a system of the present invention for a motor racing simulation game. The system comprises a main computer 1 into which pre-race data and real time data is uploaded. The uploaded data is processed in the main computer 1 into a form suitable for being downloaded into a computer console 2 running a base program. It is envisaged that the computer console 2 may alternatively, be a ‘dumb terminal’, the base program and the downloaded data being stored on a computer on the internet and accessed by the dumb terminal. Preferably, the computer console 2 is a home games console with a broad band data input, such as an optical fibre input, or an ADSL input (Asymmetric Digital Service Line providing between 500 kb to 2 Mb of incoming bandwidth and 256 kb of outgoing bandwidth) or an ISDN input. A suitable console is the Play Station II™ sold by Sony Corporation or the X-Box™ sold by the Microsoft Corporation.

Pre-race data comprises track information, background and car set up.

The track information comprises: the form of the race track, including shape, camber and curbs; the wear qualities of the track, such as the roughness and the adhesive qualities of the track; the position of the pits and signals and pit boards, location of the marshals, curbs, run-off areas, access ways, and barriers.

The track is scanned using a scanning device 3 such as that disclosed in PCT Publication No. WO 97/40342 in the name of Cyra Technologies, Inc. and sold under the trade mark CYRA 3D Laser Mapping System. This type of scanner is able to scan large areas, up to a loom radius to within 2 mm of accuracy. The scanning device 3 located at a first spot at the beginning of the track. The first spot is at a known position or a position which can be derived, the known position defined by, for example, an x-y-z Cartesian or polar coordinates, thus a segment of the track is scanned from a known location. The scanning device 3 is then moved to a second spot which is also at a known position or at a position, which can be derived and a second segment is scanned. This is repeated until the entire track is scanned. The segmented scanned images are then put together to form a complete image or mesh of the entire track. The mesh is made up of a series of points which may be defined by x-y-z Cartesian coordinates and/or polar coordinates and may be placed in the a matrix describing a mesh. The scanning procedure may be conducted without a known absolute position. The track may simply be mapped in several sections and pasted together using relative positions, such as the sides of adjacent sections of scanned track. Tracks are usually in the form of loops, the first section of scanned track should meet up with the final section of scanned track. The mesh is then uploaded into the main computer 1. The mesh is then processed into a form suitable for loading into the base program. The processing may include an encoding step and/or compressed. The known absolute positions may be obtained from a GPS reading.

The reflectivity of the track gives an indication of its colour, which may be used to expedite the formation of the computer model for insertion into the base program of the simulation. The digitised image may be rendered and polygonised.

The adhesive and wear qualities of the track can be assessed using current techniques and measurements, or from data obtained from the track owners such as a Shore hardness test. This data is then uploaded into the main computer 1, processed into data which will be accepted by the base program and may be encoded and/or a compression step.

The positions of the signals and marshals can be obtained from the race stewards computer 4, or from physical measurements and uploaded into the main computer 1, processed into data which will be accepted by the base program and may be encoded and/or compressed.

The scanner 3 may also be used to scan details such as curbs, banks of corners, surrounding barriers and pit lanes. It is envisaged that each track will be scanned a few days before each race. This is due to the fact that tracks are frequently modified prior to each race. However, if the track is not altered between seasons, the track needn't be re-scanned.

The background may include details such as grandstands, trees, buildings and pit lane garages and other equipment located near to the racetrack. These details can be rendered using standard items taken from directories of background information, or be rendered by scanning the background using the scanner in a similar manner to that described above.

The background such as grandstands, crowds, landscape and grasslands, may be filmed or scanned and superimposed during the pre-race data set up stage. The fixed background graphics, such as landscape, buildings and grandstands may be filmed or scanned over a period of time—pre-race and downloaded as pre-race data. The variable background, such as crowds and pit lane crew may change whilst the game is being played, and therefore may be downloaded in real time as real time data.

The car set up data can be determined by the dynamic capabilities of each of the cars. For instance, if the player wanted to choose a car from a particular team, for example McLaren, the dynamic capabilities would be downloaded from stored information taken during warm up or qualifying data. The particular data used may include telemetric data used by the teams, such as the speed at each point along the track. This may then be used to set the fastest speed the player's car will go at any point along the track. This is one way of determining the player's car's ‘optimum’ capabilities during the subsequent race. The player may be provided with control to vary this aspect to allow the player an advantage over the real cars and/or to compensate for differences in a car's dynamic capabilities between warm up, qualifying and race set ups. Other dynamic factors may be used in the alternative or additionally, such as the rate at which the car can accelerate and decelerate, and cornering ability. A ‘prediction’ program may then be used to assess the ‘optimum’ capabilities of the altered set-up, as explained with reference to the following alternative or complimentary method.

Another method of obtaining the player's car's ‘optimum’ capabilities is to use a test car, such as' a Formula 3000 car fitted with a plurality of sensors. The test car is driven around the circuit prior the race. Once the car has completed what is reckoned to be a ‘perfect’ lap, the data for that lap is inserted into a prediction program, such as that provided by D.A.T.A.S. Ltd and sold under the trade name Race Sim. To obtain a prediction of a differently set up Formula 3000 car, or even a prediction of a different type of car, the prediction program provides an input screen for inserting relevant parameters of the differently set up Formula 3000 car or different car. The prediction program then calculates a ‘perfect’ lap for that car and defines the car's ‘optimum’ capabilities i.e. the program estimates the fastest speed attainable at any point on the circuit for a car with the parameters entered in the prediction program.

During a live race, the ‘optimum’ capabilities of the player's car may be based on the preceding lap times of the real life, leading car of the race. This would be particularly useful in situations in which the track conditions have changed since qualifying or using a test car or changed during the race. Such conditions are rain, strong sunshine, snow or sleet. For instance, at the apex of a first corner, a car's maximum speed may be 160 km/hr, however in rain the maximum speed may be 100 km/hr and even less in heavy rain. As the ‘optimum’ capabilities of the player's car is based on the actual real life car's, the player will be on an even footing with the real cars, which should result in a pleasing and realistic race.

The data from the real life leading car may be taken from a preceding lap and inserted into a the prediction program described above, which would then give a prediction of the player's car's ‘optimum’ capabilities at each point along the track. This would be particularly useful if the leading car was using wet weather tyres and the player is using slick tyres for instance.

It may be advantageous to obtain an average of a few leading cars in order to obtain a better estimation of the actual ‘perfect’ lap at that particular time, given the track conditions. This may be advantageous if one of the leading cars is being held up by a back marker or is slowing due to technical difficulties or a crash. It is preferable that cars that are held up by back markers or technical problems are not used for this purpose. Another option would be to have a pace car, which would provide consistent data for gauging the ‘optimum’ capabilities in varies track condition changes.

Real time data may comprise each real competitor's car's position, orientation, road wheel orientation, steering wheel position, fuel load, the load on each wheel, and possibly the overall down force acting on the car and also comprises real time track conditions, such as dampness and wetness of the track, track temperature and ambient temperature, pressure and humidity. Each car's position on the track can be determined from a sensor on the car, which is standard equipment in many race series, such as Formula 1, Formula 3000 and Indy racing. Each car's position may be obtained from a Global Positioning System (GPS), in conjunction with a local beacon. Positions may be taken as regularly as once every second, but preferably once every one hundredth of a second, in order to obtain an accurate representation of the course the car is taking. It is understood that the position of the car can be assessed using GPS and local GPS reference markers, up to an accuracy of around 10 mm. The local GPS reference markers may not be required, as readings taken directly from satellites are now very accurate. The GPS position is obtained in at least two dimensions, thereby providing a position, not only along the track, but also transversely, across the track. A Global Positioning coordinate may be overlayed on to a three dimensional mesh of the track in order to obtain the exact position of each car. This can be achieved by knowing the height above sea level of each point on the track and knowing where the GPS device is located on each car.

Knowing the transverse position of each car across the track is advantageous, in that an accurate representation across the track is useful for virtual player's to see the lines which the real drivers are taking for learning purposes, as well as for overtaking opportunities in a race. This data may be uploaded into the main computer 1, processed, possibly including an encoding step, for onward transmission to a computer holding the base program.

Other sensors on each car can transmit other data, which can be used to better simulate the competitors' positions and characteristics for the simulation game. The sensors transmit data back to their team's computers and to the steward's computer via a telemetric system.

A second sensor is also located on the car, spaced from the first sensor at a distance, preferably at least half of the car's length and most preferably the first and second sensors are located at opposite ends of the car. A second GPS co-ordinate is obtained for the location of the second sensor. This enables the orientation of the car to be obtained, assuming that the car lies in a substantially horizontal plane or a plane substantially parallel with the track. This location co-ordinate is sent in real time to the main computer with the first reading. In this way, the orientation, as well as the position of the race car will appear in the computer simulation.

Instead of a second sensor, a gyroscopic device may be located in the race car, such that data regarding the orientation of the race car can be obtained and sent in real time to the main computer, with the first reading.

The simulation game may be played using: a monitor 7 or television for displaying the graphic images of the simulation game; a steering wheel 8 for an interface; a set of pedals 9 for an additional/alternative interface; a keyboard 10 for an additional/alternative interface; and a seat arrangement 11 for the player with an integral stand 12 for a monitor. A simulator may comprise any of the before mentioned items and may be installed in a racing car shell or part of a shell, and may have an active base, and active smell system thus adding to the realism aspect of the simulation. The user interface may include controls such as a steering wheel, gear stick and pedal arrangement which comprise active feedback features, such as a vibrating steering wheel. Also sound effects may be added, such as engine noise, crowd noise and other ambient noises which may be real time actual sounds. In operation, the player downloads the basic program from the main computer hub 1 to the player's console 2 via the internet (or via a satellite link) or loads the basic program from a Compact Disk. The player then logs-on via the internet (or satellite link) to the main computer 1. The player will be assigned a code after having answered a few questions about a preferred setup. For example, questions regarding the player's competence as a driver, driver ability, preferred type of car and of various aspects concerning the car. The player will also be provided with a schedule setting out the times of the/each race. The pre-race data is then downloaded by the player from the main computer 1 via the internet (or via satellite link) to the player's console 2 or loaded from a Compact Disk, at some time before the race is due to begin, typically one hour, one day, one week, one month, or one year before the race. Immediately prior to the race, the player may have to download an update to the pre-race data, if any recent changes to the track or other changes to the pre-race data have occurred. The Player may be notified before the race is about to begin. A test signal may be sent via the real time data link to test to establish whether the data stream is unbroken. Real time data will then be streamed to the player's console. Graphical images of the cars competing in the real race will appear on the screen 7 of the player's console 2, overlying the images of the track and surroundings produced by the basic program using the pre-race data. An in-screen window of video of the event may be shown on the screen 7.

The data sent between the base program and the main computer 1 and the sensors on the cars and the track, may travel over the internet, and/or over a dedicated telephone line and/or via satellite.

It is envisaged that pre-race data will be downloaded through the internet or via a television link such as via digital cable or digital satellite. The quantity of pre-race data is fairly large, in the order of 10 to 1,000 mb. The data may pass directly into a broad bandwidth input of a games console, such as that provided on the Play Station II™. This data may be stored in a hard drive, burnt to a CD or reside in live memory such as RAM. Or may be purchased as a CR ROM off the shelf.

The real time data may be sent via the internet, however, due to the way data is sent over the internet i.e. in compressed packets of data and the fact that the speed of transfer of data across the internet is variable, it is preferable to ‘stream’ data through a cable or via satellite. Methods used by cable and satellite television channels for transmission of their programs is preferred.

A further arrangement of such a communication system is shown in FIGS. 2a and 2b. Real time data from the race track 20 is streamed from a mobile TV/data unit 25 located at the track side via at least one satellite 21 and onwardly streamed to a player's computer console 22, being received directly by a player's own satellite dish used to pick up satellite television broadcasts or via a main satellite dish and relayed through a cable network 23. The player's consoles 22 may be located anywhere in the world. Streaming of real time data across satellites 22 is usually consistent and fast. The real time data may be compressed before sending and expanded after having been received. The real time data may be sent parallel to or in the same bandwidth as a television, video broadcast.

The real time data is preferably, streamed along with a real time video image of the event, such that real time video images reach the player at a near identical time to the real time data, preferably within a few hundredths of a second. A feature of the invention is that a video image of the race may be displayed in a window in the competitive simulation game. Another feature is that television commentary could be relayed through the player's console 22. Both of these features will give the player further insight into the position of his competitors, the state of the race and let the player's have access to hints and tips from the commentators concerning such aspects as the weather and strategy.

The position and orientation of the race cars is obtained from GPS devices 27 on each race car via a GPS satellite 26.

Information from the stewards computer 28 is obtained via a communication channel, such as a Land Area Network hard wire link or Blue Tooth link.

The real time data may also be forwarded to a data storage computer 24 for use at a future time which may be during the race. This is particularly useful for players who have missed the start of the race. The storage computer 24 may also contain player's data sent from the player's console about the player's performance. The player's data may then be used to create a league. The results of the league may be displayed on a website.

The amount of real time data may be small, perhaps requiring a bandwidth of 1 Kb/s to 10 Kb/s if simply the positions of the competitive objects is transferred. However, if other information is sent in real time the bandwidth may need to be of the order of 10 Kb/s to 8 Mb/s. Such other information may include: competitor's car's position, orientation, road wheel orientation, steering wheel position, fuel load, the load on each wheel, and possibly the overall down force acting on the car and also comprises real time track conditions, such as dampness and wetness of the track, track temperature and ambient temperature, pressure and humidity.

The data may be compressed before sending and decompressed at the player's console. Compression and decompression of data takes time and therefore all the data may have to be buffered and then used to provide a realistic uninterrupted play. Another broad bandwidth line which may be used is an Asymmetric Digital Service Line (ADSL). This provides means for consoles to receive large quantities of data very quickly. It will be appreciated that the role of racing with real life competitors will not be totally interactive, as for instance if the player's car will not affect the competitor in real life. However, in the simulation game one of a number of possibilities exists. In particular, if the player appears to hit a competitor's car, the base program may incorporate an algorithm which handles the representation of the competitor's car appear to wobble and then return to the car's real life track position and orientation thereafter, thus giving an illusion of the interaction whilst retaining the reality of the race positions.

If the representation of a competitor in the real race is hit in the simulation by a player, the simulation may change the rendering of the competitor's actual position on the track from a full image of the race car to a “ghost image” representing the race car. Meanwhile, a full image of the race car's path is estimated and shown in the simulation. For example, if the player hit the representation of the competitor sufficiently hard to send the representation of the competitor's race car off spinning off the track and into a wall, a full image of the race car would be seen on the simulation spinning off the track and into the wall and a ghost image of the competitor will follow the actual competitor's position of the track in the real life event. The ghost image may then have no effect as a competitor in the simulated race.

If the player's car hits a competitor's car hard, the base program may execute an algorithm incorporated into the base program which will make the representation of the competitor's car on screen to spin off of the track and go out of the race. A visible structure of the car will disappear from the rest of the race. The final result of the race will be different from that of reality, however, this will introduce a more interactive element to the game.

If a real car's position hits the player's car in the simulation, the player's car may wobble, or cause the player's car to spin off, or damage a part of the player's body work. Because the driver of a real car does not ‘see’ the player's car, the program may provide a function to allow the simulated real cars to pass through the players car, not affecting the player's car at all or at least minimally.

If a player has missed the start of the race and still wants to join in, he may do so in a similar manner to the series of operations described above. The player will have two options: to start the race ten laps behind; or to play from the beginning of the race by time shifting the real time data. The real time data may be stored in the main computer hub 1, or in the player's console or from a separate computer at the trackside. The main computer hub 1 may be located at the site of the event, in this case, the trackside. The data is time-shifted. If the data is stored on the main computer hub 1, the data may be stored and relayed from the main computer hub 1 to the player's console on demand. The real time video of the event may also be stored in the main computer hub 1 or the player's console 2. The real time video window will show the race time-shifted by an equal time, thereby giving the impression of being in a live race.

During the race, the position of the player's car may be forwarded to the main computer hub 1 or other computer in an intranet or on the internet. This data can be used by in real time or at another time by another player(s). This enables other players to play against the player, as well as playing against the real life competitors. This also enables results to be used in league tables, such as fasted lap and overall winner of virtual leagues and over the real life results. The leagues could be grouped by age of contestant, type of virtual car used, the set-up used and the number and type of driver aids used.

Alternatively, simply the final results could be forwarded to a website or the main computer 1 for comparison with other results from the real life event and/or other virtual players.

It is envisaged that the track could be scanned using a scanner in an air borne vehicle such as an aeroplane. The aeroplane may then pass over the track, scanning the entire track in one sweep. The mesh that results can be uploaded into the main computer 1 and processed as described hereinbefore. It is also envisaged that once a track has been scanned and mapped on to a computer, the scanned image could be used to aid designers in the future alteration of the track or in designing new tracks.

The base program may include a decoder 5 for decoding encoded data downloaded from the main computer 1.

If desired, the base program could be downloaded on to a remote server, for example on the internet and/or via satellite 6.

A real time game played using the computer simulation program may be recorded and replayed for the purposes of instruction and debriefing. The recording may be made on a hard disk, to RAM or any other storage medium.

The computer simulation program may have an option to ‘ride with a competitor’. The controls may also be reactive in response to the real driver's inputs. This may be used as an instructional tool. In this case, more information would be required from at least one of the cars of the competitors. Such additional information may comprise: extent of depression of brake pedal and accelerator pedal; steering wheel position; gear selection. This would require sensors for each of the above for providing information to be sent to the main computer hub for processing before being sent on to the base program.

The base program may be flexible enough to accept different sorts of competitive games, such that simply the pre-race data need be downloaded for a plurality of events. The sorts of events that may be downloaded into the base program are: motor bike racing, truck racing, rallying, moto cross, horse riding, swimming, fishing, cycling, jet skiing, snow skiing, sailing and motor boat racing.

It is envisaged that information regarding the real car's track position as well as obtaining data about the track may be obtained from digitised pictures from a video camera, which may be rendered and polygonised. The cameras may be placed on the cars. The digitised pictures can be analysed by a computer to assess positions, distances and orientation on the track.

It is also envisaged that the position of the cars on the track may be obtained from other positioning sensors. For example, three beacons may be located about the track, a triangulation can be made to determine the position of each car, in a horizontal plane.

It is also envisaged that two players will be able to play from the same personal computer/games console. This can be achieved with two controller interfaces and a split screen display.

Other inputs can be measured and used in the simulation, such as steering.

The base program may incorporate a menu giving the user an option to compete with the real life competitors on various levels, from amateur to professional.

Television coverage of a race is not always complete. Camera placement about a track is expensive. Only a limited part of the racetrack is covered at any one time. There are often ‘black spots’ which aren't covered by the cameras. If an incident occurs in a ‘black spot’, such as an overtaking manoeuvre, a retirement or a crash, the incident cannot be shown to a viewer. A simulation of the incident may be rendered by: obtaining the position and orientation data of the race car; and obtaining background information, such as the track, curbs, run-off areas, crowds and grandstands; and rendering them together to form a picture which can be sent, broadcast or otherwise shown to a viewer or player of a simulation game. This series of steps can be carried out several times per second in order to form a moving image, similar to filmed video footage.

In this way, a viewing point can be chosen at will and replayed from various angles. This may reduce the number of cameras required and increase the possible viewing points for the viewer or player. This can be shown in real time or after the incident has occurred or been noticed.

If more than one competitor is involved in the incident, the further competitor's position and orientation can be determined and the further competitor is rendered on to the rendered background information.

This simulation may be used by the race stewards. This would be particularly useful in assessing if a competitor has infringed the rules during the race.

Referring to FIG. 3a, there is shown a snap shot of a race car 30 driving around a corner 29 at speed. The race car 30 is shown at a point where forces act so as to push the right hand side of the car outwards and downwards. This occurs in motion, and is difficult to replicate in a stationary mode. An enlarged view of the rear right hand side of the race car 30, with parts cut away, is shown in FIG. 3b, which shows part of a suspension arrangement 31 comprising a damper 32 and a partly compressed spring 33.

Data logging equipment is well known in Formula 1 and other formulas. The data logged by the teams is typically speed of the car. The data is typically logged evey one hundredth of a second to obtain a graph, such as the one shown in FIG. 3c. The x-axis represents distamce along the track and the y-axis represents speed. Three lines are shown, each representing one lap of a circuit. Differences between laps can be seen from the graph. However, it would be useful for both the driver and the race engineer to see how the suspension is reacting at any point on the circuit, and to have a view of exactly where the car is on the race track at any point in time. Accordingly, using the above described simulation, an engineer can take a view point, such as from behind and view the race car in relation to the background information. This may then be compared in concert with the data logger display. An engineer will have a clearer view of what is going on with the race car on the actual race track.

The data logged may also comprise such data as acceleration, deceleration, centripetal forces.

A further addition to the realism of the simulation would be to add a third GPS device is located to one side of the race car. The combination of the three GPS devices means that roll in the race car can also be detected and measured, as well as pitch.

A further sensor is located on the steering column to sense the actual orientation of the wheels could be added, which, in addition to at least two GPS devices, would allow the engineer to monitor under steer or over steer occurring at any point on the circuit.

This simulation may be used to facilitate Engineer training as well as driver training and race car preparation.

Referring to FIG. 4, there is shown a simulation system generally identified by the reference numeral 50. The simulation system is similar to the system as disclosed herein with reference to the preceding Figures. The event, which the simulation system simulates is a cycling race, such as the Tour de France. The simulation system 50 comprises a computer 51, which may be a personal computer or a games console such as that sold by Sony Corporation under the name PlayStation II™ or the X-Box™ sold by the Microsoft Corporation. An exercise or training machine, in this case an exercise or training bike 52 is linked to the computer 51, via a bus link 53. The bus link 53 provides a means for signals to flow bi-directionally between the computer 51 and the exercise bike 52. The bus link 53 may be in the form of a wireless link, such as that proposed under the project name “Bluetooth”. The simulation system 50 also comprises a visual display, such as a widescreen television or a monitor 54. An external link 55 is provided. The external link 55 is preferably a cable link to a satellite dish 56, but may be an internet link.

Prior to the road bicycling event such as the Tour de France, the roads on which the race takes place is scanned with a scanner 57. The scanner may be of the type referred to above. The scanned images are uploaded to a main computer 58. The scanned images are recorded by the computer in the form of co-ordinates, which are then sent via a data link satellite 59 or via the internet to the computer 51.

The simulation system may be used when the road bicycling event begins. Real life competitors 60, 61, 62 and 63 are each provided with a device (not shown) which receives data regarding the competitor's positional co-ordinates from a Global Positioning Satellite 64 or from other positioning beacons 65 or a combination of both. The positional co-ordinates are sent in the form of data to the main computer 58 via an aerial 66. The positional data is then sent from a satellite dish 67 to a data link satellite 59 and onward to satellite dish 56 and on to computer 51.

The positional data is used, in conjunction with the scanned data, on a base program held on the computer 51, to provide a realistic simulation. The user pedals the exercise bicycle 52 using pedals 68 driving a road wheel 69. A small rotatable wheel (not shown) is located on a frame of the bicycle. The small rotatable wheel rests against a rim of the driven wheel 69. The small rotatable wheel drives a device, which translates the number of revolutions of the small wheel into an electrical signal. The electrical signal is sent to the computer 51. The computer 51 translates the electrical signal into an estimate of the speed at which the bicycle would progress, if it were a real bicycle. This speed is used to place the user amongst the real life competitors.

The scanned image of the track is also used to gauge a steepness of the track. This can be assessed from an average taken between points of the mesh on which the scanned image is based. If, for example, at one point, the track has a 30 degree incline, the computer will send a signal on bus link 53 to the exercise bike 52. The signal will be used to increase the resistance against the users pedalling. This may be accomplished by applying a breaking force to the rear wheels.

Other inputs can be measured and used in the simulation, such as steering.

The base program may incorporate a menu giving the user an option to compete with the real life competitors on various levels, from amateur to professional.

The simulation system of FIG. 5 is generally similar to the simulation system of FIG. 4. However, the exercise machine is a rowing machine. The event which the simulation system simulates is a rowing race, such as the Oxford and Cambridge Boat Race. The simulation system 150 comprises a computer 151, which may be a personal computer or a games console such as that sold by Sony Corporation under the name PlayStation II™ or the X-Box™ sold by the Microsoft Corporation. An exercise machine, in this case a rowing machine 152, such as a Concept II™ ergo, is linked to the computer 151, via a bus link 153. The bus link 153 provides a means for signals to flow bi-directionally between the computer 151 and the rowing machine 152. The bus link 153 may be in the form of a wireless link, such as that proposed under the project name “Bluetooth”. The simulation system 150 also comprises a visual display, such as a widescreen television or a monitor 154. An external link 155 is provided. The external link 155 is preferably a cable link to a satellite dish 156, but may be an internet link.

Immediately prior to the rowing event such as the Oxford and Cambridge boat race, the river on which the race takes place is scanned with a scanner 157. The scanner may be of the type referred to above. The scanned images are uploaded to a main computer 158. The scanned images are recorded by the computer in the form of co-ordinates, which are then sent via a data link satellite 159 or via the internet to the computer 151. It is preferable to carry out this procedure close to the race, in order to obtain an image of the river at the correct tide height.

The simulation system 150 may be used when the rowing event begins. Boats 160, 161, 162 and 163 are each provided with a device (not shown) which receives data regarding the competitor's positional co-ordinates from a Global Positioning Satellite 164 or from other positioning beacons 165 or a combination of both. The positional co-ordinates are sent in the form of data to the main computer 158 via an aerial 166. The positional data is then sent from a satellite dish 167 to a data link satellite 159 and onward to satellite dish 156 and on to computer 151.

The positional data is used, in conjunction with the scanned data, on a base program held on the computer 151, to provide a realistic simulation. The user pulls on chord 168 driving a fan 169. A small rotatable wheel (not shown) is located on the frame of the rowing machine 152. The small rotatable wheel rests against a rim of hub of the fan 169. The small rotatable wheel drives a device, which translates the number of revolutions of the small wheel into an electrical signal. The electrical signal is sent to the computer 151. The computer 151 translates the electrical signal into an estimate of the speed at which the boat would progress, if it were in the race. This speed is used to place the user amongst the real life competitors.

A prediction of the currents of the river is used to gauge a resistance to apply to the rowing machine. If, for example, at one point, the river has a current approaching two knots into the bow of the boat, the computer 151 will send a signal on bus link 153 to the rowing machine 152. The signal may be used to decrease the indicated speed of the simulated boat (rowing machine) by two knots and/or will be used to increase the resistance against the users pulling in the simulated boat (rowing machine). This may be accomplished by applying a breaking force to the fan 169.

1. A competitive simulation game comprising a base program and at least one controllable object controllable by a player, characterised in that, in use, a real time input from a real life game controls the position of a competitive object in the competitive simulation game as a competitor to the player, the position defined by a coordinates in at least one plane.

2. A competitive simulation game as claimed in claim 1, wherein the real time input comprises at least one other descriptive element of said object.

3. A competitive simulation game as claimed in claim 1 or 2, obtaining position coordinates in at least two planes.

4. A competitive simulation game as claimed in claim 1, 2 or 3, wherein the real time input comprises a description of said object's orientation.

5. A competitive simulation game as claimed in any preceding claim, wherein said object is a vehicle.

6. A competitive simulation game as claimed in any preceding claim, wherein the real time input includes at least one of the following descriptive elements of said vehicle: road wheel orientation; steering wheel orientation; and fuel load.

7. A competitive simulation game as claimed in any preceding claim, wherein the real time input is uploaded into the base program via a broad bandwidth line.

8. A competitive simulation game as claimed in any preceding claim, wherein the real time data is sent in a bit stream.

9. A competitive simulation game as claimed in any preceding claim, wherein the real time input is uploaded from the real life game to the internet, and downloaded into a base program from which said competitive simulation game is played.

10. A competitive simulation game as claimed in any preceding claim wherein, the base program is stored on a personal computer or games console.

11. A competitive simulation game as claimed in any preceding claim, wherein the base program is stored on a computer forming part of the internet, which may be accessed through a dumb terminal.

12. A games console comprising the competitive simulation game claimed in any preceding claim.

13. A simulator comprising the competitive simulation game as claimed in any of claims 1 to 11.

14. A training simulator comprising the competitive simulation game as claimed in any of claims 1 to 11.

15. A method of obtaining track surface data comprising the step of scanning the track to obtain a computer generated scanned image of the track, and inserting the scanned image of said track into a computer program.

16. The method as claimed in claim 15, wherein said scanning step is conducted from a series of defined points located around said track.

17. The method as claimed in claim 15 or 16, wherein said scanning step is conducted from an aeroplane or helicopter or airship or balloon.

18. The method as claimed in claim 15, 16 or 17, wherein the track comprises one of the following: a tarmac looped track, such as that used in Formula 1, Indy car or Nascar; a road track, such as that used in bicycle road races, such as the Tour de France; a substantially mud track, such as used in car rallying, moto cross or mountain bike races; and a river including river banks, such as that used in boat races, such as the stretch of the Thames used in the Oxford and Cambridge boat race.

19. The method as claimed in any of claims 15 to 18, wherein the scanning step is conducted immediately prior to an event occurring on the track.

20. The method as claimed in any of claims 15 to 19, wherein said computer program is a base program of a racing simulation game.

21. The method as claimed in any of claims 15 to 20, further comprising the step of combining the scanned image of said track with track conditions and track properties obtained from other means.

22. The method as claimed in any of claim 15 to 21, wherein said track conditions and properties include at least one of adhesive qualities, temperature, humidity, dampness, wetness and visibility.

23. A computer simulated track modelled using the method set out in claims 15 to 22.

24. An apparatus for inserting pre-race data into base program, said apparatus comprising means for obtaining said pre-race data, means for uploading said pre-race data on to the internet and means for downloading said pre-race data into said base program.

25. A method for inserting pre-race data into a base program, said method comprising the steps of obtaining said pre-race data, uploading said data on to the internet and downloading said pre-race data into said base program.

26. A method of obtaining data for a simulated car competing against representations of real cars on a track said method comprising the steps of obtaining data from a real car driving on a track and using said obtained data for obtaining an approximation of said simulated car's ‘optimum’ capabilities.

27. A method as claimed in claim 26, wherein said ‘optimum’ capabilities are used in a car racing game.

28. A method as claimed in claim 27, wherein said obtained data comprises the speed at at least one point on said track.

29. A method as claimed in claim 26, 27 or 28, wherein said obtained data is obtained from a near perfect performance from said car on said track.

30. A method as claimed in any of claims 26 to 29, wherein said obtained data is obtained before said competition.

31. A method as claimed in any of claims 26 to 30, wherein said obtained data is obtained from said real car during said competition.

32. A method as claimed in claim 31, wherein said obtained data is obtain from an average or otherwise statistically derived method of at least two real cars during said competition.

33. A method as claimed in any of claims 26 to 32, wherein said obtained data is processed using a prediction program, such that said simulated car's parameter's are also submitted to said prediction program to obtain an approximation of said simulated car's ‘optimum’ capabilities.

34. A competitive simulation game comprising an algorithm to carry out the method as claimed in any of claim 26 to 33.

35. A method of transferring real time data relating to an event for use in a competitive simulation characterised in that said real time data is transmitted via a satellite link.

36. The method as claimed in claim 35, wherein the real time data is received directly from said satellite link at the location of the player.

37. The method as claimed in claim 39, wherein the real time data is received directly from said satellite link at a station and into a cable network for onward transmission to the location of the player.

38. The method as claimed in claim 34, 35, 36 or 37 further comprising the step of simultaneously transmitting said real time data of an event with a televisual signal of the event.

39. The method as claimed in any of claims 35 to 39, further comprising the step of transmitting said real time data to a website on the internet, to which player's have access.

40. The method as claimed in claim 39, further comprising the step of making available pre-race data on said website on the internet, to which player's have access.

41. The method as claimed in any of claims 35 to 40, wherein said pre-race data is also transmitted via a satellite link.

42. The method as claimed in any of claims 35 to 41, wherein said event comprises an object and said real time data comprises a position coordinates of said object.

43. A simulation system comprising position co-ordinates for at least one competitor in a real life event on a track, a computer for processing an image and position of said competitor on a representation of the track on a visual display and a user input device emulating the competitors, characterised in that said user input device is an exercise machine.

44. A simulation system as claimed in claim 43, wherein the position co-ordinates are obtained using a Global Positioning Satellite.

45. A simulation system as claimed in claim 44, wherein said position co-ordinates are obtained using a beacon.

46. A simulation system as claimed in claim 43, 44 or 45, wherein the event takes place at a location remote from the simulation system.

47. A simulation system as claimed in any of claims 43 to 46, wherein the track comprises one of the following: a tarmac track, a looped track, a road track, a muddy road and a river.

48. A simulation system as claimed in any of claims 43 to 47, wherein the event comprises one of the following: a velodrome cycling event a road bicycle event, a mountain biking event, a walking event, a running event, and a rowing event.

49. A simulation system as claimed in any of claims 43 to 48, wherein a scanned image of the track is obtained, the scanned image loaded on to said computer and displayed on said visual display.

50. A simulation system as claimed in any of claims 43 to 49, wherein the position co-ordinates of the at least one competitor are transmitted from said event via satellite link.

51. A simulation system as claimed in any of claims 43 to 50, wherein the position co-ordinates may be transmitted over the internet.

52. A simulation system as claimed in any of claims 43 to 51, wherein advertising banners appear on the visual display, which are associated with the event, or are linked with a user or user profile of the simulation system.

53. A method of training or exercising using the simulation system as claimed in any of claims 43 to 52 comprising the stop of competing in virtual reality with at least one competitor in real time.

54. A competitor provided with a device for assessing the competitor's position co-ordinates, which device transmits said position co-ordinates to a main computer (51,101) for onward transmission to a simulation system as claimed in any of claims 43 to 52.

55. A competitor as claimed in claim 54, wherein said competitor competes on a bicycle or a rowing boat, said device for assessing the competitor's position co-ordinates located on said bicycle or said rowing boat.

56. A competitor as claimed in claim 54 or 55, wherein said device reassesses said position co-ordinates and transmits said position co-ordinates to said main computer between every hundredth of a second and every five seconds.

57. A computer program for use in the simulation system as claimed in any of claims 43 to 52, wherein said program includes an algorithm to accept positional co-ordinates and use them to display an image of the competitors cars on a visual display.

58. A simulation comprising the steps of obtaining positional data from a competitor in an event, obtaining background information, rendering a representation of said competitor, rendering said background information and placing said representation of said competitor on to the rendered background information to form a picture and broadcasting or sending said picture to at least one viewer.

59. A simulation as claimed in claim 58, wherein said positional data is obtained using a GPS device arranged on said competitor.

60. A simulation as claimed in claim 58 or 59, further comprising the step of obtaining data regarding the orientation of competitor and orientation of the background, rendering a representation of said competitor therewith for placement on to said rendered background, such that the viewer will have an accurate representation of the orientation of the competitor in relation to the background.

61. A simulation as claimed in claim 60, wherein the data regarding the orientation of the competitor is obtained using a second GPS device arranged on said competitor and spaced in a first direction from said first GPS device.

62. A simulation as claimed in claim 61, wherein the data regarding the orientation of the competitor is obtained using a third GPS device and spaced in a second direction from said first GPS device, preferably orthogonal to said first direction.

63. A simulation as claimed in claim 61, wherein the data regarding the orientation of the competitor is obtained using a gyroscopic device.

64. A simulation wherein the steps in the simulation as claimed in any of claims 58 to 63, are carried out once every 25^{th} of a second to obtain a moving video simulation.

65. A simulation wherein the steps in the simulation as claimed in any of claims 58 to 63, is carried out once every 50^{th} of a second to obtain a moving video simulation.

66. A simulation as claimed in any of claims 58 to 65, wherein the simulation is carried out on the instruction of the viewer.

67. A simulation as claimed in any of claims 58 to 65, wherein the simulation is carried out by a commentator, editor or director of a broadcaster.

68. An apparatus including a computer for carrying out the simulation as claimed in any of claims 58 to 67.

69. A simulation comprising the steps of obtaining positional data from a competitor in an event, obtaining background information, rendering a representation of said competitor, rendering said background information and placing said representation of said competitor on to the rendered background information to form a picture and sending said picture to at least one viewer and obtaining and displaying logged data next to said picture.

70. A simulation as claimed in claim 69, wherein siad positional data is obtained using a GPS device arranged on said competitor.

71. A simulation as claimed in claim 70, wherein the simulation further comprises the step of obtaining data regarding the orientation of the competitor and orientation of the background, rendering a representation of said competitor therewith for placement on to said rendered background, such that the viewer will have an accurate representation of the orientation of the competitor in relation to the background.

72. A simulation as claimed in claim 71, wherein the data regarding the orientation of the competitor is obtained using a second GPS device arranged on said competitor and spaced in a first direction from said first GPS device.

73. A simulation as claimed in claim 72, wherein the data regarding the orientation of the competitor is obtained using a third GPS device and spaced in a second direction from said first GPS device, preferably orthogonal to said first direction.

74. A simulation as claimed in claim 73, the data regarding the orientation of the competitor is obtained using a gyroscopic device.
A third GPS device may be arranged on a side of the car to obtain data regarding roll and pitch of the race car.

75. A simulation as claimed in any of claims 69 to 74, wherein the steps of the simulation are carried out once every 25^{th} of a second to obtain a moving video simulation, such that 25^{th} pictures are formed every second.

76. A simulation as claimed in any of claims 69 to 74, wherein the steps of the simulation are carried out once every 50^{th} of a second.

77. A simulation as claimed in any of claims 69 to 76, wherein the logged data is displayed at the same intervals as the pictures.

78. A simulation as claimed in any of claims 69 to 77, wherein the logged data comprises at least one of the following: the speed, acceleration, deceleration, centripetal forces and weight of the race car.

79. A simulation as claimed in any of claims 69 to 78, wherein the logged data is displayed on a graph.
